(19) United States
(12) Patent Application Publication
(10) Pub. No.: US 2008/0300771 A1
(43) Pub. Date: Dec. 4, 2008

(54) IRREGULAR DETECTION DEVICE AND FUEL INJECTION SYSTEM USING THE SAME

(75) Inventor: Shinya SUMITANI, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/128,984

(22) Filed: May 29, 2008

(30) Foreign Application Priority Data
May 30, 2007 (JP) 2007-144009

(51) Int. Cl. F02D 41/00

(52) U.S. Cl. 701/103

(57) ABSTRACT

In a fuel injection system, an ECU judges occurrence of cylinder misfire based on a variation of the number of rotation speed of a diesel engine when an ignition judgment condition is satisfied after the diesel engine starts. If there is a non-ignition cylinder, the increased number of rotation speed of the diesel engine becomes in general smaller than a predetermined value. The ECU gets a common rail pressure corresponding to the non-ignition cylinder, and then judges whether or not a correct pressure variation occurs. The ECU then judges the occurrence of malfunction of the fuel injection valve when the decreased value of the corresponding common rail pressure is out of a normal range, The ECU judges the condition of each cylinder based on the judgment result regarding whether or not the fuel injection valve correctly injects the fuel into the corresponding cylinder.

### CROSS-REFERENCE TO RELATED APPLICATION

This application is related to and claims priority from Japanese Patent Application No. 2007-144009 filed on May 30, 2007, the contents of which are hereby incorporated by reference.

### BACKGROUND OF THE INVENTION

1. Field of the Invention

The present invention relates to an irregular detection device for internal combustion engines such as diesel engines, and a fuel injection system using an irregular detection device equipped with fuel injection valves (or fuel injectors) for injecting the fuel into respective cylinders of the internal combustion engine.

2. Description of the Related Art

There are fuel injection systems capable of judging whether or not normal ignition is correctly carried out in respective cylinders in an internal combustion engine such as a diesel engine based on the rotation speed of the internal combustion engine. For example, Japanese patents JP 2712332 and JP 3036351 have disclosed such fuel injection systems.

Although the occurrence of the ignition failure in respective cylinders can be judged based on the variation of the rotation speed of the internal combustion engine, it is difficult to determine, based on the variation of the rotation speed of the internal combustion engine, whether it is caused by (A1) operational failure of the fuel injection valves or (A2) by another failure other than (A1) in spite of correctly injecting the fuel into the respective cylinders. As a result, even though the occurrence of ignition failure of respective cylinders in the internal combustion engine can be judged, it is difficult to determine which falls in the failure state, the fuel injection valves or the internal combustion engine or both.

### SUMMARY OF THE INVENTION

It is an object of the present invention to provide an irregular detection device and a fuel injection system using an irregular detection device capable of correctly judging the cause of the ignition failure.

To achieve the above purposes, the present invention provides an irregular detection device capable of judging (1) whether or not respective fuel injection valves (or fuel injectors) correctly inject fuel into corresponding cylinders in an internal combustion engine based on an instructed injection amount, and (2) whether or not respective cylinders correctly ignite, and (3) whether or not each cylinder correctly ignites even though the corresponding fuel injection valve correctly injects the fuel based on the judgment results (1) and (2).

According to the present invention, it is possible to precisely and correctly judge whether the target cylinder ignites or not even though the fuel injection valve (or the fuel injector) injects the fuel into this target cylinder based on the instructed injection amount by using the combination of the above judgment results (1) and (2), namely, the combination of the injection judgment of the fuel injection valves and the ignition judgment of the cylinders. It is thereby possible that when the fuel injection system using the irregular detection device is mounted to a vehicle, the driver can select and take the most appropriate action according to the cylinder-ignition condition because the above judgments correctly determine the cause of the cylinder non-ignition state as being caused by either a malfunction of the fuel injection valve or by a malfunction of the internal combustion engine side.

In accordance with another aspect of the present invention, there is provided an irregular detection device capable of judging whether or not the fuel injection valve correctly injects the fuel into the corresponding cylinder based on the instructed injection amount after the judgment result indicates that the corresponding cylinder does not ignite even though the fuel injection instruction is transferred to the fuel injection valve.

Thus, the irregular detection device judges the following states (4) and (5).

(4) The state in which the cylinder does not ignite even though the fuel injection instruction is transferred to the fuel injection valve; and

(5) The state of whether the fuel injection valve correctly injects the fuel into the corresponding cylinder.

Thereby, it isn't necessary to arbitrarily perform the judgment of whether or not the fuel injection valve correctly injects the fuel into the corresponding cylinder at any time based on the instructed injection amount. The only time it can be judged is when the cylinder does not ignite when the fuel injection instruction is transferred to the fuel injection valve. As a result, this can decrease the load of the injection judgment process.

In accordance with another aspect of the present invention, there is provided a fuel injection system having a fuel feed pump, a common rail, a plurality of fuel injection valves (or fuel injectors), and the irregular detection device. The fuel feed pump is configured to forcedly feed fuel. The common rail is configured to accumulate the fuel forcedly fed from the fuel feed pump. The fuel injection valves are configured to inject the fuel supplied from the common rail into corresponding cylinders of an internal combustion engine. The irregular detection device according to the present invention is configured to detect irregular states of the fuel injection valves and the cylinders of the internal combustion engine.

### BRIEF DESCRIPTION OF THE DRAWINGS

A preferred, non-limiting embodiment of the present invention will be described by way of example with reference to the accompanying drawings, in which:

FIG. 1A is a block diagram showing a fuel injection system using an irregular detection device according to the first embodiment of the present invention;

FIG. 1B is a schematic view of one fuel injection valve as an injector and a four-cylinder diesel engine as an internal combustion engine;

FIG. 2 is a flow chart showing an irregular detection routine performed by the irregular detection device shown in FIG. 1A;

FIG. 3 is a flow chart showing an ignition judgment routine performed by the irregular detection device shown in FIG. 1A;

FIG. 4 is a flowchart showing a normal injection judgment routine performed by the irregular detection device shown in FIG. 1A;

FIG. 5 shows variation of a rotation speed of each cylinder of an internal combustion engine; and

FIG. 6 shows a variation of a common rail pressure when the respective injection valves inject the fuel into the corresponding cylinders of the internal combustion engine.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

A description will be given of the fuel injection system using the irregular detection device according to the first embodiment of the present invention with reference to figures.

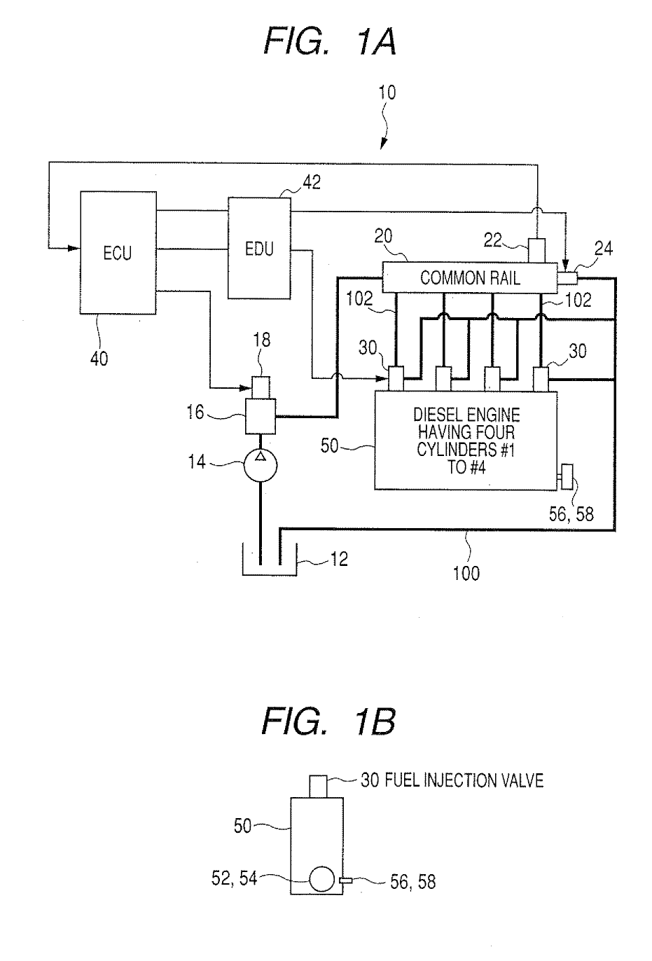

FIG. 1A is a block diagram showing the fuel injection system 10 using the irregular detection device according to the first embodiment of the present invention. FIG. 1B is a schematic view of one fuel injection valve 30 as an injector and a four-cylinder diesel engine 50 as an internal combustion engine.

As shown in FIG. 1A, the fuel injection system 10 of an accumulator type is comprised of a feed pump 14, a high pressure pump 16, a common rail 20, a pressure sensor 22, a reduction valve 24, four fuel injectors 30, an electronic control unit (ECU) 40, an electronic driving unit (EDU) 42, and the like. Because each injector has an electromagnetic valve, it is hereinafter referred to as the “fuel injection valve 30”. The fuel injection system 10 injects the fuel of a specified amount into each cylinder (as each combustion chamber) in the four-cylinder diesel engine 50. Although FIG. 1A only shows a control line from the EDU 42 to one fuel injection valve 30 for brevity, the EDU 42 is actually connected to each fuel injection valve 30 through each control line.

The feed pump 14 sucks the fuel stored in the fuel tank 12 and feeds the fuel to the high pressure pump 16.

The high pressure pump 16 is a well-known pump for sucking the fuel into a pressure chamber and then compressing this fuel in the pressure chamber by a reciprocating motion of a plunger that is performed by rotating a cam of a camshaft.

The ECU 40 controls a current to be supplied to a variable valve 18 in the high pressure pump 18 in order to adjust the fuel sucking volume of the high pressure pump 16 during the sucking process.

The amount of fuel to be supplied to the common rail 20 from the high pressure pump 16 is adjusted by controlling the fuel suction amount.

The common rail 20 receives a high pressure fuel supplied from the high pressure pump 16 and accumulates the fuel therein. The common rail 20 maintains the high pressure fuel therein at a predetermined high pressure according to the engine operation condition.

The pressure sensor 22 as a pressure detection means detects the pressure in the inside of the common rail 20 and outputs the detection signal to the ECU 40.

The reduction valve 24 discharges the fuel in the common rail 20 into a low-pressure return pipe 100 when it opens. For example, the reduction valve 24 is a well-known electromagnetic valve having an electromagnetic driving unit such as a coil. The electromagnetic driving unit lifts a valve member up against a spring force when turning on electricity and the reduction valve 24 thereby opens.

The opening period of time of the reduction valve 24 is changed according to a pulse width of a pulse supplied to the reduction valve 24.

Each fuel injection valve 30 is placed for the corresponding cylinder in the four-cylinder diesel engine 50. Each fuel injection valve 30 injects the fuel accumulated in the common rail 20 into the inside of the corresponding cylinder #i (i=1 to 4).

The fuel injection valves 30 perform multi-injection steps including a main injection and a pilot injection per combustion cycle. The fuel injection valves 30 are connected to the common rail 20 through injection pipes 102. Each fuel injection valve 30 is a well-known electromagnetic driving valve whose fuel injection amount is adjusted by controlling a pressure of a control chamber by adding a fuel pressure to a fuel nozzle so that the fuel nozzle needle is closed.

The ECU 40 as the irregular detection device is realized by a microcomputer composed mainly of a central processing unit (CPU), a read only memory (ROM), a random access memory (RAM), and a nonvolatile memory such as writable flash memory.

In the ECU 40, various programs are stored in the memory means such as the ROM or the flash memory. Those programs serve as an ignition judgment means, an injection judgment means, an irregular judgment means, an irregular estimation means, a rotation speed obtaining means, a pressure obtaining means, an injection compensation means, and a stop instruction means.

The ECU 40 receives various detection signals which are transferred from an acceleration sensor, a temperature sensor, a pressure sensor 22, a NE sensor 56, a cylinder judgment sensor 58, and the like. The ECU 40 then judges the operation condition of the diesel engine 50 based on the detection signals. The acceleration sensor detects an accelerator pedal opening ratio, the NE sensor 56 detects NE (as the number of a rotation speed of the internal combustion engine), and the cylinder judgment sensor 58 judges the specified cylinder.

In order to achieve optimal operational conditions for the diesel engine 50, the ECU 40 controls the electrical power supply into the regulator valve 19, the reduction valve 24, and the fuel injection valves 30 based on the obtained operation condition of the diesel engine 50.

The ECU 40 controls the injection period of time and the fuel amount or volume of injection of each fuel injection valve 30 according to the engine operation condition that is obtained by analyzing the detection signals transferred from the various sensors including the pressure sensor 22. The ECU 40 generates and outputs a pulse signal to the EDU 42. This pulse signal is an injection driving signal to control the injection period of time and the fuel injection amount of each fuel injection valve 30.

The ECU 40 and the EDU 42 act as an injection control means for controlling the injection operation of each fuel injection valve 30.

The ECU 40 judges based on the pressure variation of the common rail 20 or the injection pipe 102 whether or not the fuel injection valve 30 correctly injects the fuel into the corresponding cylinder #i based on an instructed injection amount.

In the first embodiment, based on the detection signal transferred from the pressure sensor 22 that detects the pressure of the common rail 20, the ECU 40 performs the above judgment, whether or not the fuel injection valve 30 correctly injects the fuel into the corresponding cylinder.

Further, based on the pulse signals transferred from the NE sensor 56 and the cylinder judgment sensor 58, the ECU 40 detects how many times each cylinder rotates, and then judges whether or not each cylinder ignites based on the variation in the number of engine rotation.

The ECU 40 stores into the flash memory a characteristic map regarding a discharging amount of the high pressure pump 16 corresponding to the electric power to be supplied to the variable valve 18 according to the engine driving condition.

The ECU 40 performs a feedback control in order to control the electric power supplied to the variable valve 18 so that the pressure of the common rail 20 obtained by the pressure sensor 22 becomes the target pressure of the common rail 20 based on the characteristic map stored in the flash memory regarding the discharging amount characteristic of the high pressure pump 16.

The EDU 42 is a driving device for supplying the driving current or voltage to the reduction valve 24 and each fuel injection valve 30 based on the control signal output from the ECU 40.

An engine rotation pulser 52 and a cylinder judgment pulser 54 are mounted to the crank shaft of the diesel engine 50. The engine rotation pulser 52 (hereinafter referred to as the “NE pulser 52”) detects the rotation number of the diesel engine 50 as the internal combustion engine. The cylinder judgment pulser 54 detects the cylinder position of the diesel engine 50.

A plurality of projections is placed on the NE pulser 52 at a predetermined regular angle in a circumferential direction. The NE sensor 56 detects the projections formed on the NE pulser 52 which rotates together with the crank shaft and outputs the pulse signal every detection of each projection. The ECU 40 calculates how many times each cylinder in the diesel engine 50 rotates based on the number of pulse signals per time transferred from the NE sensor 56.

The projections are formed at a predetermined angle interval on the cylinder judgment pulser 54 for judging the position of the four cylinders of the diesel engine 50. On detecting the projections of the cylinder judgment pulser 54, the cylinder judgment sensor 58 generates and outputs a pulse signal. The ECU 40 receives the pulse signals transferred from the NE sensor 56 and the cylinder judgment sensor 58, and then calculates the crank angle of the diesel engine 50 based on the received pulse signals.

### (Irregular Detection)

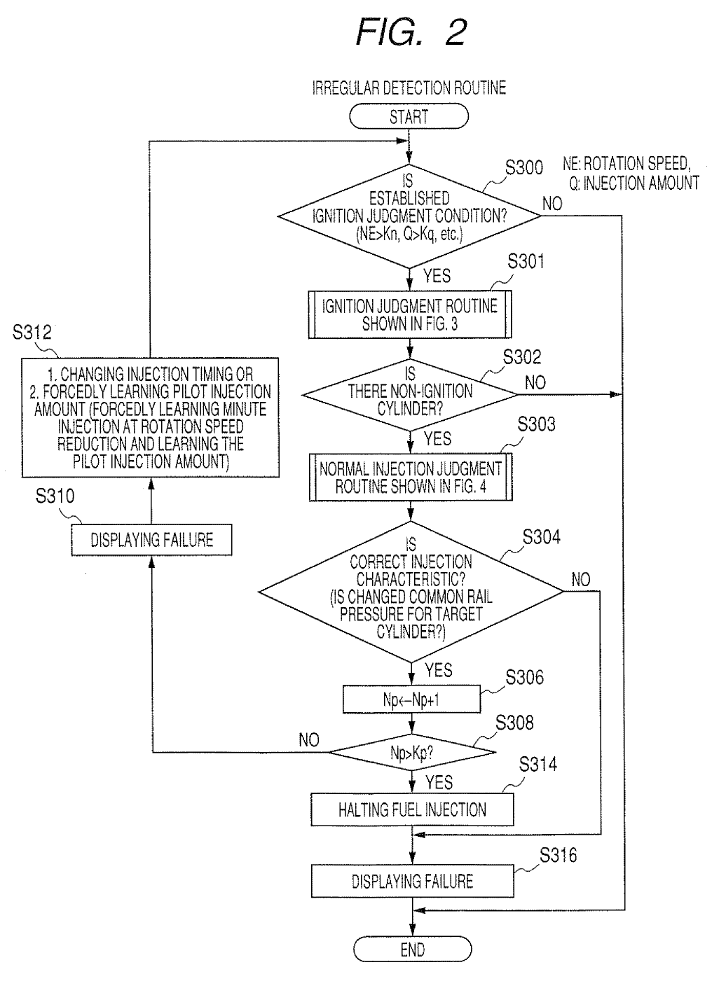

A description will now be given of the irregular detection routine performed by the fuel injection system 10 with reference to FIG. 2 to FIG. 4.

FIG. 2 is a flow chart showing the irregular detection routine performed by the irregular detection device shown in FIG. 1A. The main loop program for the engine control includes this irregular detection routine. The ECU 40 as the irregular detection device always performs the irregular detection routine in the main loop program for the engine control.

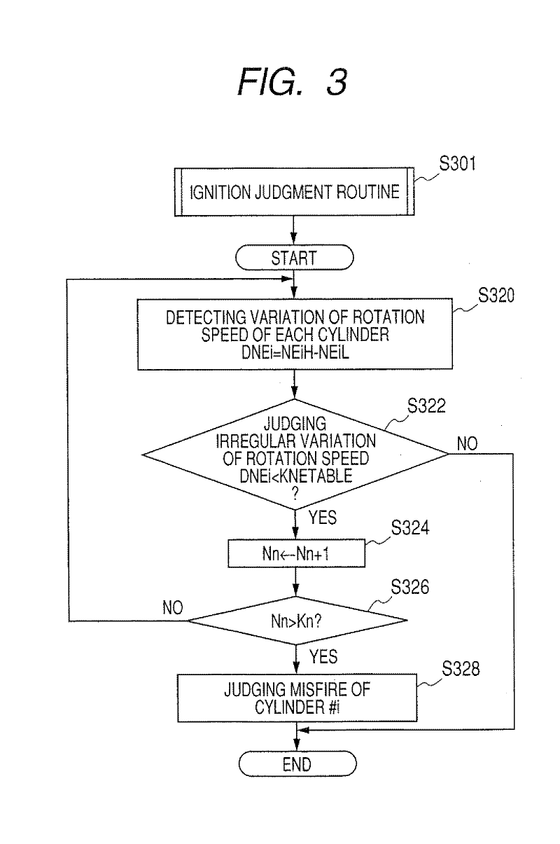

FIG. 3 is a flow chart showing the ignition judgment routine performed by the irregular detection device shown in FIG. 1A. The ignition judgment routine judges whether or not each cylinder in the diesel engine 50 correctly ignites.

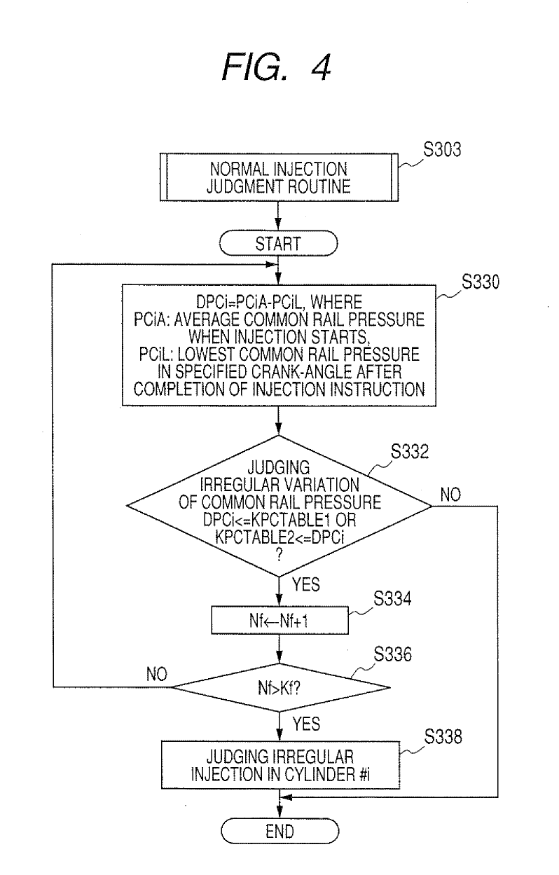

FIG. 4 is a flowchart showing the normal injection judgment routine performed by the ECU 40 as the irregular detection device shown in FIG. 1A. The normal injection judgment routine performs whether each fuel injection valve 30 correctly injects the fuel into the corresponding cylinder based on the instructed injection amount. Those routines shown in FIG. 2, FIG. 3, and FIG. 4 are realized by the programs that are stored in the memory device such as the flash memory.

In particular, the judgment at step S302 and the judgment at step S304 shown in FIG. 2 are carried out based on the execution results in the ignition judgment routine shown in FIG. 3 and the injection judgment routine shown in FIG. 4, respectively.

In the irregular detection routine shown in FIG. 2, the ECU 40 firstly judges whether or not the ignition judgment condition is established in the diesel engine 50 (step S300).

For example, when the rotation speed (NE) of the internal combustion engine becomes more than a predetermined value Kn and the injection amount or volume (Q) becomes more than a predetermined value Kq after the diesel engine 50 starts, the ECU 40 judges that the ignition condition has been established (“Yes” in step S300).

In this case, the ECU 40 executes the ignition judgment routine shown in FIG. 3 at step S301. The ignition judgment routine will be explained later in detail with reference to FIG. 3. After completion of the ignition judgment routine at step S301 shown in FIG. 3, the operation flow goes to step S302.

On the other hand, at step S300, when the ECU 40 judges that the ignition condition is not yet established (“No” in step S300), the operation flow goes out of this routine, namely, the ECU 40 completes the irregular detection routine shown in FIG. 2.

Returning to step S302, the ECU 40 judges whether or not there is any non-ignition cylinder in the four cylinders. When judging that all of the four cylinders have already ignited (“No” in step S302), the ECU 40 completes this irregular detection routine.

On the other hand, at step S302, the ECU 40 judges that there is at least one non-ignition cylinder (“Yes” in step S302), the operation flow goes to the normal injection judgment routine at step S303 shown in FIG. 4.

The ECU 40 executes the normal injection judgment routine at step S303 shown in FIG. 4. The normal injection judgment routine will be explained later in detail with reference to FIG. 4. After completion of the normal injection judgment routine at step S303 shown in FIG. 4, the operation flow goes to step S304.

In step S304, the ECU 40 gets the common rail pressure of the cylinder that does not ignite, and judges whether or not the corresponding fuel injection valve 30 correctly injected the fuel based on the instructed injection amount. This judgment uses the pressure decreasing characteristic of the common rail pressure which changes in synchronization with the instructed injection amount for the fuel injection valve 30.

The ECU 40 judges that the injection characteristic of the fuel injection valve 30 is normal when the pressure decreasing characteristic of the common rail pressure is normal. The operation flows then goes to step S306.

On the other hand, the ECU 40 judges that the injection characteristic of the fuel injection valve 30 is abnormal when the pressure-decreasing characteristic of the common rail pressure is abnormal. In this case, the operation flow goes to step S316.

In step S304, the normal state of the pressure decreasing characteristic indicates that the common rail pressure is normally decreased by correctly injecting the fuel through the fuel injection valve 30 based on the instructed injection amount into the corresponding cylinder.

On the other hand, in step S304, the abnormal state of the pressure decreasing characteristic indicates that the common rail pressure is not correctly changed through an error occurring in the operation of the fuel injection valve 30, where the fuel injection valve 30 does not inject a predetermined amount of fuel based on the instructed injection amount in spite of already transmitting the injection instruction to the cylinder that does not yet ignite. That is, this means that there is a possibility that the fuel injection valve 30 itself falls into error condition or wiring and the like connected to the fuel injection valve 30 falls into error condition.

It is thereby possible to estimate that the operation failure occurs in the fuel injection valve 30. Accordingly, in step S304, if the pressure decreasing characteristic of the common rail pressure is irregular, namely, abnormal (“No” in step S304), the operation flow goes to step S316. In step S316, the ECU 40 displays a message regarding the failure of the fuel injection valve 30 on a display means (not shown). When watching this message displayed on the display means, the driver of the vehicle can take timely and appropriate action such as stopping and inspecting the vehicle followed by maintenance.

Further, the ECU 40 does not instruct the fuel injection valve 30 to increase the fuel injection amount corresponding to the normally-igniting cylinder in order to compensate insufficient engine torque even though the ECU 40 judges as the causes of non-ignition that the fuel injection valve 30 does not correctly inject the fuel into the corresponding cylinder in step S304.

This can protect the EGR (Exhaust Gas Recirculation) amount from any shifting of a target value, and avoid emission deterioration.

In step S306, the ECU 40 increments an irregular judgment counter Np by +1. When the routine shown in FIG. 2 starts, the initial value such as zero is set into the irregular judgment counter Np.

In step S308, the ECU 40 judges whether or not the irregular judgment counter Np exceeds a predetermined value Kp.

When the judgment result indicates that the irregular judgment counter Np does not exceed a predetermined value Kp (Np <=Kp), the ECU 40 displays the message “Although injection system is normal, failure occurs in the Internal combustion engine side” on the display means and the like at step S310.

The ECU 40 learns a pilot injection amount by shifting the injection timing of the fuel injection valve 30 toward one of the lead-angle side and the delay-angle side, or by forcedly performing a minute amount injection.

The learning of the pilot injection amount, which is common knowledge, is performed by detecting any variation of the rotation speed of the diesel engine 50 using the NE sensor 56, for example.

As described above, after the injection timing and the pilot injection amount of the fuel injection valve 30 is learned and compensated, it tries to perform the ignition of the cylinder, which did not ignite even though the fuel injection valve 30 injected the fuel, using the compensated injection timing and fuel amount.

In step S312, although step S312 in the flowchart shown in FIG. 2 selects and performs one of the injection timing compensation processes and the pilot injection amount compensation for the fuel injection valve 30, it is also possible to combine those compensations.

When the above non-igniting cylinder ignites using the compensation value of the injection timing or/and the compensation value of the pilot injection amount, the ECU 40 judges that the abnormal ignition has already been avoided, namely, there is no cylinder that does not ignite (“No” in step S302). The operation flow then goes out of this routine. The ECU 40 completes the irregular detection routine.

Return to step S308, when the judgment result indicates that the irregular judgment counter Np exceeds the predetermined value Kp (Np>Kp), the ECU 40 judges that the target cylinder does not ignite even though the fuel injection valve 30 injects the fuel to the corresponding target cylinder after learning the fuel injection timing or the pilot injection amount, and compensates several times the fuel injection timing or the pilot injection amount.

In step S314, the ECU 40 then instructs to the fuel injection valve 30 corresponding to the target cylinder to halt the fuel supply.

In this case, because the ECU 40 instructs the fuel injection valves correspond to the cylinders other than such a failure cylinder to continue the fuel supply, the driver can carefully and continuously drive the vehicle.

According to the present invention described above, it is possible to protect the non-ignition cylinder from the fuel supply of the corresponding fuel injection valve 30, and also makes it possible to avoid discharging un-combusted fuel from the cylinder which did not ignite.

As a result, this avoids combusting the fuel on the catalyst in a particulate matter (PM) purifying filter which is placed at the downstream side of the exhaust gas discharging system, observed from the diesel engine 50 side, it is thereby possible to carry out a regular regeneration-cycle of the particulate matter purifying filter with catalyst.

At step S316, the ECU 40 displays the message regarding “Failure” on the display means, and completes this irregular detection routine shown in FIG. 2.

When the fuel injection valve 30 does not correctly inject the fuel to the corresponding cylinder, the ECU 40 displays the message “Fuel injection valve failure” on the display means.

When the cylinder does not ignite in spite of correctly injecting the fuel from the corresponding fuel injection valve 30, and when the cylinder cannot ignite even through the injection amount of the fuel injection valve 30 is compensated, the ECU 40 displays the message “Failure of the internal combustion engine” on the display means.

Because the driver of the vehicle can recognize the type of failure regarding the fuel injection valve 30 and the internal combustion engine (or diesel engine), it is possible to select the optimum treatment such as ceasing to drive, inspection and maintenance according to the failure type displayed on the display means.

As prescribed above, according to the first embodiment of the present invention, the ECU 40 judges whether or not the fuel injection valve 30 correctly injects the fuel into the corresponding cylinder in step S304 in the irregular detection routine shown in FIG. 2, the ECU 40 displays the failure message on the display means in step S310 when the cylinder does not ignite in spite of correctly injecting the fuel by the corresponding fuel injection valve 30, or when the failure occurs in the internal combustion engine although the fuel injection system composed of the fuel injection valves 30 correctly operates.

The driver of the vehicle can recognize the failure occurrence in the internal combustion system side even though the cylinder ignites after the compensation of the injection timing or the injection amount in step S312.

### (Ignition Judgment)

A description will now be given of the ignition judgment routine shown in FIG. 3.

FIG. 3 is the flow chart showing the ignition judgment routine performed by the ECU 40 as the irregular detection device in the fuel injection system 10 shown in FIG. 1A.

The ECU 40 executes the ignition judgment routine shown in FIG. 3 to judge whether or not respective cylinders correctly ignite. This ignition judgment routine shown in FIG. 3 is performed after step S300 and before the step S302 shown in FIG. 2

In step S320 in the ignition judgment routine shown in FIG. 3, the ECU 40 receives the detection signals transferred from the NE sensor 56 and the cylinder judgment sensor 58, and calculates the variation of the rotation speed of each cylinder #i (where, i=1 to 4) in the four-cylinder diesel engine 50.

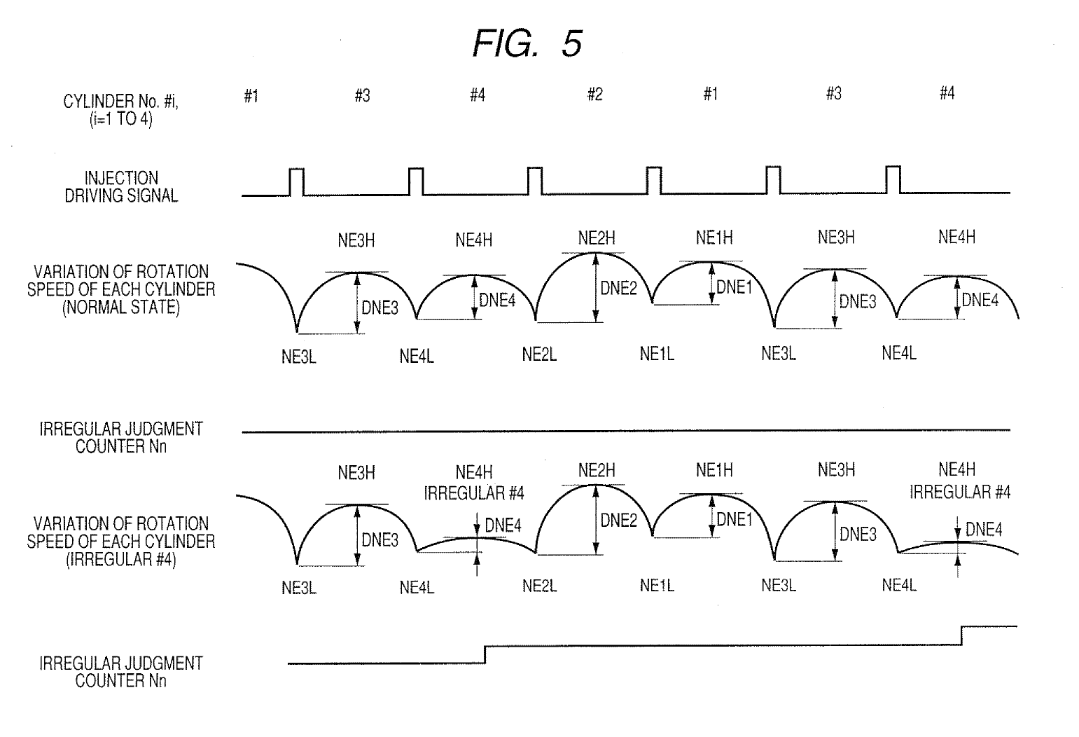

FIG. 5 shows the variation of the rotation speed of each cylinder #i (where, i=1 to 4) in the four-cylinder diesel engine 50. Specifically, as shown in FIG. 5, the ECU 40 calculates the variation value DNEi (i=1 to 4) which is the increased number obtained by subtracting the minimum value NEiL from the maximum value NEiH, based on the following equation (1),

DNEi=NEiH−NEiL (1),

where NEiH is the maximum value of the variation of the rotation speed of each cylinder #i when the ECU 40 instructs the injection instruction to the corresponding fuel injection valve 30 to initiate the fuel injection, and the minimum value is the rotation speed of each cylinder #i at the starting time when the variation of the rotation speed occurs,

In step S322, the ECU 40 judges whether or not the variation value DNEi of the rotation speed of the cylinder is smaller than a predetermined value KNETABLE, where the variation value DNEi of the rotation speed of the cylinder is changing in synchronization with the injection instruction to the corresponding fuel injection valve 30.

The ECU 40 further judges whether the variation value DNEi of the rotation speed of the diesel engine 50 (as the internal combustion engine) is abnormal or not when the ECU 40 instructs the fuel injection valve 30 corresponding to each cylinder #i to inject the fuel. FIG. 5 shows the example of the variation value DNE4 of the rotation speed of the cylinder #4, which is abnormal, namely, smaller than the predetermined value KNETABLE.

When the variation value DNEi (where, i=1 to 4) is more than the predetermined value KNETABLE (DNEi<KNETABLE), the ECU 40 as the irregular detection device judges that the variation value DNEi is too small because this target cylinder #i does not ignite (“Yes” in step S322). In this case, the operation flow goes to step S324 in the flowchart shown in FIG. 3.

On the other hand, when all of the cylinders #i (i=1 to 4) satisfies the relationship of DNEi >=KNETABLE (namely, “No” in step S322), the ECU 40 as the irregular detection device judges that all of the cylinders #i (i=1 to 4) normally ignite. In this case, the ECU 40 completes this ignition judgment routine shown in FIG. 3. At this time, the ECU 40 sets a misfire flag of each cylinder #i to OFF, for example.

The operation flow returns to the irregular detection routine shown in FIG. 2 from the ignition judgment routine at step S301 shown in FIG. 3. In the irregular detection routine shown in FIG. 2, the operation flow then goes to step S302.

In step S302, the ECU 40 judges whether or not a cylinder has misfired based on the value “ON” and “OFF” of the misfire flag.

Returning to step S322 in the ignition judgment routine shown in FIG. 3, the relationship DNEi<KNETABLE is satisfied, the ECU 40 adds the value “1” to the irregular judgment counter Nn at step S324.

At the beginning of the ignition judgment routine shown in FIG. 3, the ECU 40 sets the value “zero” to the irregular judgment counter Nn, for example.

In step S326, the ECU 40 judges whether or not the irregular judgment counter Nn does not exceed a predetermined value Kn. When the judgment result indicates that the irregular judgment counter Nn does not exceed the predetermined value Kn (“No” in step S326), the operation flow returns to step S320 at the beginning of the ignition judgment routine shown in FIG. 3. The ECU 40 then performs the process of step S320 again.

On the other hand, when the judgment result indicates that the irregular judgment counter Nn exceeds the predetermined value Kn (“Yes” in step S326), the operation flow goes to step S328. In step S328, the ECU 40 judges that the target cylinder is in the misfire condition, does not correctly ignite even through the ECU 40 has several times instructed the corresponding fuel injection valve 30 to inject the fuel. At this time, the ECU 40 further sets “ON” to the misfire flag, which indicates that the target cylinder falls in the misfire condition.

The operation flow returns to the irregular detection routine shown in FIG. 2 from the ignition judgment routine shown in FIG. 3. The ECU 40 then performs step S302. In step S302, the ECU 40 judges whether or not there is a cylinder having the misfire flag of ON.

### (Normal Injection Judgment)

A description will now be given of the normal injection judgment routine shown in FIG. 4 as the subroutine designated by step S303 in FIG. 2.

FIG. 4 is a flowchart showing the ignition judgment routine performed by the ECU 40 as the irregular detection device shown in FIG. 1A.

The ECU 40 executes the normal injection judgment routine shown in FIG. 4 before executing the step S304 in the irregular detection routine shown in FIG. 2.

The description according to the first embodiment is based on the assumption in which the common rail pressure is decreased according to the instructed injection amount and the number of rotations of the diesel engine 50 when the ECU 40 instructs the respective fuel injection valves 30 to inject the fuel to the corresponding cylinders #i (i=1 to 4).

In step S330 in the normal injection judgment routine shown in FIG. 4 (as step S303 in FIG. 2), the ECU 40 receives the detection signal transferred from the pressure sensor 22, and calculates the variation value of the common rail pressure of the common rail 20 that changes in synchronization with the injection instruction from the ECU 40 to each cylinder when instructing the fuel injection valve 30 to inject the fuel. Specifically, the ECU 40 calculates the variation value DPCi of the common rail pressure by the following equation (2),

DPCi=PCiA−PCiL (2),

where PCiA is an average pressure of the common rail pressure at the injection start timing when the ECU 40 instructs each fuel injection valve 30 to inject the fuel into the corresponding cylinder, and PCiL is the minimum common rail pressure within a crank angle that is set after the ECU 40 completes the fuel instruction injection to the fuel injection valves 30.

In step S332, the ECU 40 judges whether or not the variation value DPCi of the common rail pressure is greater than a predetermined value KPCTABLE1 and is smaller than a predetermined value KPCTABLE2. The ECU 40 further judges that the variation value DPCi of the common rail pressure is normal or abnormal based on the above comparison result.

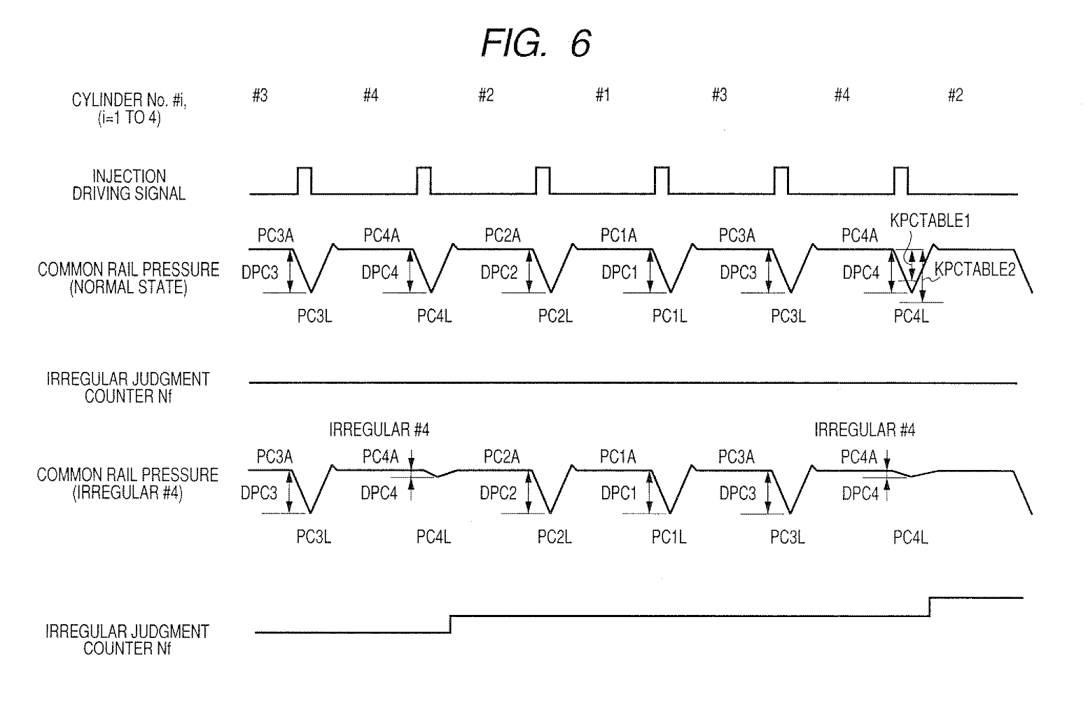

FIG. 6 shows an example in which the variation value DPC4 of the common rail pressure becomes smaller than the predetermined value KPCTABLE1 (DPC4<KPCTABLE1) when the ECU 40 instructs the fuel injection valve 30 to inject the fuel into the corresponding cylinder #4.

When the judgment result at step S332 indicates that the relationship DPCi<=KPCTABLE1 or KPCTABLE2<=DPCi is satisfied, the ECU 40 judges that the fuel injection valve 30 does not correctly inject the fuel into the target cylinder (“Yes” in step S332) even though the ECU 40 has instructed this fuel injection valve 30 to inject the fuel. The operation flow then goes to step S334.

On the other hand, in step S332, when the common rail pressure is decreased within the range of KPCTABLE1<DPCi<KPCTABLE2 and the common rail pressure then rises, the ECU 40 judges that the fuel injection valve 20 correctly injects the fuel into the target cylinder #i although the target cylinder #i does not ignite. In this case, the ECU 40 completes the normal injection judgment routine shown in FIG. 4. The ECU 40 further sets an irregular injection flag of this target cylinder #i to OFF, for example.

The operation flow returns to the irregular detection routine shown in FIG. 2, and goes to step S304.

In step S304 shown in FIG. 2, the ECU 40 judges whether or not the variation of the common rail pressure is within a predetermined range, where the variation of the common rail pressure is caused by the fuel injection of the fuel injection valve 30 corresponding to the target cylinder #i, and wherein this target cylinder #i does not ignite based on the value (ON or OFF) of the irregular injection flag which corresponds to this target cylinder #i.

Returning to step S334 in the normal injection judgment routine shown in FIG. 4, the ECU 40 sets the value of “1” to the irregular judgment counter Nf (Nf+1--->Nf). This irregular judgment counter is initially set to a value of zero when the normal injection judgment routine shown in FIG. 4 starts.

At step S336 in the normal injection judgment routine in FIG. 4, the ECU 40 judges whether or not the irregular judgment counter Nf exceeds a predetermined value Kf.

When the judgment result indicates that the irregular judgment counter Nf does not exceed a predetermined value Kf (“No” in step S336), the operation flow returns to step S330 in FIG. 4.

On the other hand, when the judgment result indicates that the irregular judgment counter Nf exceeds a predetermined value Kf (“Yes” in step S336), the operation flow goes to step S338 in FIG. 4.

In step S338, the ECU 40 judges that the fuel injection valve 30 does not correctly inject the fuel to the corresponding cylinder because the variation value DPCi of the common rail pressure is out of the range KPCTABLE1<DPCi<KPCTABLE2 even though the ECU 40 has several times instructed the fuel injection valve 30 to inject the fuel into the corresponding cylinder where this instruction is not carried out (namely, does not ignite). The ECU 40 sets the irregular injection flag corresponding to the fuel injection valve 30 ON.

The operation flow returns to the irregular detection routine shown in FIG. 2 from the normal injection judgment routine shown in FIG. 4.

The operation flow then goes to step S304 in FIG. 2.

In step S304, the ECU 40 judges whether or not the fuel injection valve 30 correctly injects the fuel to the corresponding cylinder using the ON/OFF state of the irregular injection flag.

According to the first embodiment of the present invention described above, it is possible to correctly judge whether the irregular state of the cylinder fallen in the misfire state (namely, that does not ignite) is caused by the failure of the fuel injection valve 30 or caused by the failure of the internal combustion engine rather the fuel injection valve 30. This judgment is obtained by judging whether or not the fuel injection valve 30 correctly injects the fuel into the corresponding target cylinder which, although instructions have been received, still does not ignite. The ECU 40 instructs that a certain amount is injected to the cylinders, this instruction is transferred to the fuel injection valves, and the judgment of where the error lies is based on the operation failure of the fuel injection valve 30 or the failure of the internal combustion engine side.

In particular, as in the case of the first embodiment, because the diesel engine 50 as the internal combustion engine having a plurality of cylinders operates the diesel cycle using compression self-ignition, misfiring easily and often occurs on performing the pilot ignition and the delaying of the injection timing in order to meet the combustion control and the like. According to the irregular detection device of the first embodiment of the present invention, because the non-ignition state of the cylinders in the diesel engine 50 is correctly judged, it is possible for the vehicle driver to take proper action based on the judgment result.

Further, the ECU 40 gets the common rail pressure and calculates a variation of the common rail pressure only when the ECU 40 detects the presence of the cylinder in a misfire, namely, that does not ignite and then instructs the fuel injection valve 30 corresponding to this cylinder.

It is thereby possible to decrease the processing load of the ECU 40 because the frequency of getting the common rail pressure and of calculating the variation value of the common rail pressure in order to judge whether or not the fuel injection valve 30 correctly injects the fuel to the corresponding cylinder can be decreased.

### (Other Modifications)

A description will now be given of some modifications of the first embodiment according to the present invention.

In the first embodiment, the ECU 40 firstly detects the presence of a misfire cylinder that does not ignite, then gets the common rail pressure when the ECU 40 instructs the fuel injection valve (or injector) 30 to inject the fuel into the detected misfire cylinder. The ECU 40 finally calculates the variation value of the common rail pressure.

The present invention is not limited by the above manner. For example, it is possible to judge the misfire state of the cylinders based on another procedure as follows.

The ECU 40 obtains the common rail pressure and calculates the variation of the common rail pressure every transferring the injection instruction to the fuel injection valves 30 for all the cylinders. The ECU 40 then judges whether or not the each fuel injection valve 30 injects the fuel into the corresponding cylinder based on the variation value of the common rail pressure. The ECU 40 obtains the number of the rotation speed of the internal combustion engine when instructing the fuel injection valves 30 to inject the fuel, and calculates the variation value of the rotation speed. The ECU 40 then judges whether or not each cylinder correctly ignites based on the calculated variation value of the rotation speed.

By the way, in the first embodiment, the ECU 40 judges whether or not each cylinder correctly ignite based on the calculated variation value of the rotation speed of the internal combustion engine using the detection signal transferred from the NE sensor 56.

The present invention is not limited by the above manner. For example, it is possible to judge the occurrence of misfire in each cylinder using an oxygen concentration in the exhaust gas which is discharged from the internal combustion engine during an exhaust stroke and an oxygen concentration in intake air during an intake stroke.

In order to enhance the judgment precision in the normal injection judgment routine for the fuel injection valves 30 shown in FIG. 4, prescribed above, it is possible to add, as one of failure diagnosis terms, the step to judge the decreasing timing when the decreasing of the common rail pressure starts after the ECU 40 instructs the fuel injection valves 30 to inject the fuel, in addition to using the variation value of the common rail pressure.

By the way, in the first embodiment of the present invention, the ECU 40 judges the irregular ignition state in the fuel injection system 10 of an accumulator type in which the fuel injection valve 30 injects the fuel accumulated in the common rail 20 into the corresponding cylinder of the diesel engine 50.

The present invention is not limited by the above manner. For example, it is possible to apply the concept of the present invention to a gasoline engine in which the fuel is injected into the gasoline engine without using any common rail. This case can perform the injection judgment, whether or not the fuel injection valves correctly inject the fuel into the corresponding cylinders of the gasoline engine, by detecting variation in pressure of the passages through which the fuel is fed to the fuel injection valves, for example.

### Other Effects

In accordance with another aspect of the present invention, there is provided the irregular detection device capable of judging whether the fuel injection valve (or the injector) correctly injects the fuel based on the instructed injection amount after it is judged that the corresponding cylinder does not ignite when the injection instruction is transferred to the fuel injection valve.

This can avoid the execution of constantly judging whether or not the respective fuel injection valves correctly inject the fuel to the corresponding cylinders based on the instructed injection amount. It is possible to perform the above judgment (namely, whether or not the fuel injection valve correctly injects the fuel to the corresponding cylinder) only when it is judged that the cylinder does not ignite. This can decrease the processing load of the correct injection judgment.

In the irregular detection device as another aspect of the present invention, because the cause of the occurrence of the non-ignition cylinder is estimated even though the fuel injection valve correctly injects the fuel to the cylinder based on the instructed injection amount, the driver of the vehicle can select and take the proper treatment and the optimum action according to the above estimation result.

In the irregular detection device as another aspect of the present invention, because the cause of occurrence of the non-ignition cylinder is estimated even through the injection instruction is transferred to the fuel injection valve, the driver can select the proper treatment and takes the optimum action according to the above estimation result.

By the way, in general, the fuel injection system detects the number of rotation speed of the internal combustion engine such as a diesel engine because the injection amount and the like are controlled based on the number of the rotation speed. According to the present invention, without incorporating any additional speed sensor for detecting the rotation speed of the internal combustion engine, the irregular detection device can judge whether the cylinder does not ignite or not using the detection signal transferred from the rotation speed sensor, mounted to the vehicle, for use of controlling the fuel injection amount for the fuel injection valves. This can correctly judge the occurrence of the cylinder ignition without adding any detection sensor.

According to another aspect of the present invention, because the irregular detection device controls the injection amount based on a common rail pressure (as a pressure value of the common rail) in case of a fuel injection system to inject the fuel stored in the common rail into the cylinders of the internal combustion engine through the fuel injection valves, the common rail pressure is in general detected using a pressure sensor mounted to the common rail.

Without additionally incorporating any additional sensor to detect the pressure of the common rail, the irregular detection device can judge whether or not the fuel injection valve correctly injects the fuel into the corresponding cylinder using the detection signal transferred from the pressure sensor which is mounted to the fuel injection system in order to control the injection amount for the fuel injection valve.

According to another aspect of the present invention, the irregular detection device compensates at least one of the injection timing or the pilot injection amount of the fuel injection valve (or the injector) when the corresponding cylinder does not ignite even though the fuel injection valve correctly injects the fuel into the corresponding cylinder based on the instructed injection amount.

There is a possibility that the misfire cylinder (or the non-ignition cylinder), although which did not ignite by malfunction of the internal combustion engine, begins to ignite due to the irregular detection device compensating for either the injection timing or the pilot injection amount.

Unfortunately, in the case that the misfire cylinder does not begin to start the ignition by compensating at either the injection timing or the pilot injection amount, the irregular detection device instructs the fuel injection valve corresponding to this misfire cylinder to halt the fuel injection. This can prevent non-combusted fuel discharging through the cylinder, which has not ignited.

Each function of the various means that form the irregular detection device according to the present invention can be realized by a combination of hardware source, whose configuration provides a specified function, and various programs stored in the memory means.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. An irregular detection device for a fuel injection system in which respective fuel injection valves inject fuel into corresponding cylinders of an internal combustion engine, comprising:
injection judgment means configured to judge whether or not the fuel injection valve correctly injects a fuel into the corresponding cylinder based on an instructed injection amount;
ignition judgment means configured to judge whether each cylinder ignites or not; and
irregular detection means configured to judge whether or not each cylinder ignites even though the corresponding fuel injection valve correctly injects the fuel based on the instructed injection amount.

2. The irregular detection device according to claim 1, wherein the injection judgment means judges whether or not the fuel injection valve correctly injects the fuel into the corresponding cylinder based on the instructed injection amount after the ignition judgment means judges that the corresponding cylinder does not ignite when the injection instruction is transferred to the fuel injection valve.

3. The irregular detection device according to claim 1, further comprising irregular estimation means configured to estimate a cause of non-ignition in the cylinder based on the judgment result of the irregular judgment means even though the fuel injection valve correctly injects the fuel based on the instructed injection amount.

4. An irregular detection device for a fuel injection system in which respective fuel injection valves inject fuel into corresponding cylinders of an internal combustion engine, comprising:
ignition judgment means configured to judge whether each cylinder ignites or not; and
injection judgment means configured to judge whether or not the fuel injection valve correctly injects the fuel into the corresponding cylinder based on an instructed injection amount after the ignition judgment means judges that the corresponding cylinder does not ignite when the fuel injection valve receives the instruction to inject the fuel into the corresponding cylinder.

5. The irregular detection device according to claim 4, further comprising irregular estimation means configured to estimate a cause of non-ignition of the cylinder based on the judgment result of the injection judgment means even though the fuel injection valve receives the instruction to inject the fuel into the corresponding cylinder.

6. The irregular detection device according to claim 1, further comprising rotation-speed number obtaining means configured to obtain the number of a rotation speed of the internal combustion engine, wherein
the ignition judgment means judges that the corresponding cylinder does not ignite when an increased number of the rotation speed of the internal combustion engine in synchronization with the injection instruction to be supplied to the fuel injection valve is smaller than a predetermined value.

7. The irregular detection device according to claim 1, wherein the fuel injection system is a system in which the fuel is fed into a common rail using a fuel feed pump, and then accumulated in the common rail, and the fuel injection valve injects the fuel accumulated in the common rail into the corresponding cylinder.

8. The irregular detection device according to claim 4, wherein the fuel injection system is a system in which the fuel is fed into a common rail using a fuel feed pump, and then accumulated in the common rail, and the fuel injection valve injects the fuel accumulated in the common rail into the corresponding cylinder.

9. The irregular detection device according to claim 7, further comprising pressure obtaining means configured to obtain a fuel pressure of the inside of the common rail, wherein
the injection judgment means judges that the fuel injection valve correctly injects the fuel into the corresponding cylinder based on the instructed injection amount by a pressure decreasing characteristic of the common rail, obtained by the pressure obtaining means, in synchronization with the injection instruction provided to the fuel injection valve.

10. The irregular detection device according to claim 8, further comprising pressure obtaining means configured to obtain a fuel pressure of the inside of the common rail, wherein
the injection judgment means judges that the fuel injection valve correctly injects the fuel into the corresponding cylinder based on the instructed injection amount by a pressure decreasing characteristic of the common rail, obtained by the pressure obtaining means, in synchronization with the injection instruction provided to the fuel injection valve.

11. The irregular detection device according to claim 7, further comprising injection compensation means configured to compensate at least one of an injection timing and a pilot injection amount when the corresponding cylinder does not ignite even though the fuel injection valve correctly inject the fuel into the corresponding cylinder based on the instructed injection amount.

12. The irregular detection device according to claim 8, further comprising injection compensation means configured to compensate at least one of an injection timing and a pilot injection amount when the corresponding cylinder does not ignite even though the fuel injection valve correctly inject the fuel into the corresponding cylinder based on the instructed injection amount.

13. The irregular detection device according to claim 11, further comprising halt instruction means configured to instruct the fuel injection valve for the corresponding cylinder to halt the fuel injection when the corresponding cylinder does not ignite even though the injection compensation means compensates at least one of the injection timing and the pilot injection amount.

14. The irregular detection device according to claim 12, further comprising halt instruction means configured to instruct the fuel injection valve for the corresponding cylinder to halt the fuel injection when the corresponding cylinder does not ignite even though the injection compensation means compensates at least one of the injection timing and the pilot injection amount.

15. A fuel injection system comprising:
a fuel feed pump configured to forcedly feed fuel;
a common rail configured to accumulate the fuel forcedly fed from the fuel feed pump;
a plurality of fuel injection valves configured to inject the fuel supplied from the common rail into corresponding cylinders of an internal combustion engine; and
the irregular detection device defined in claim 1 configured to detect irregular states of the fuel injection valves and the cylinders of the internal combustion engine.

16. A fuel injection system comprising:
a fuel feed pump configured to forcedly feed fuel;
a common rail configured to accumulate the fuel forcedly fed from the fuel feed pump;
a plurality of fuel injection valves configured to inject the fuel supplied from the common rail into corresponding cylinders of an internal combustion engine; and
the irregular detection device defined in claim 4 configured to detect irregular states of the fuel injection valves and the cylinders of the internal combustion engine.
